(19) United States
(12) Patent Application Publication
(10) Pub. No.: US 2026/0353158 A1
(43) Pub. Date: Nov. 5, 2026

(54) MEASUREMENT INFORMATION REPORTING METHOD AND APPARATUS, AND TERMINAL AND READABLE STORAGE MEDIUM

(71) Applicant: VIVO MOBILE COMMUNICATION CO., LTD., Dongguan (CN)

(72) Inventors: Chenxi WANG, Dongguan (CN); Jiangwei YUAN, Dongguan (CN); Hao WU, Dongguan (CN)

(21) Appl. No.: 19/727,365

(22) Filed: Jul. 1, 2026

Related U.S. Application Data
(63) Continuation of application No. PCT/CN2025/070245, filed on Jan. 2, 2025.

(30) Foreign Application Priority Data
Jan. 2, 2024 (CN) 202410012718.6

(51) Int. Cl. H04W 24/10; H04B 7/06

(52) U.S. Cl. CPC H04W 24/10; H04B 7/06952

(57) ABSTRACT

A measurement information reporting method and apparatus, a terminal, and a readable storage medium are disclosed in the field of communication technologies. The method in embodiments of this application includes the terminal sending target information to a network side device, where the target information includes at least one of the following: a target measurement resource index; a target measurement value, where the target measurement value includes at least one of a sub-band measurement value and a wideband measurement value; and antenna characteristic information of the terminal.

### CROSS-REFERENCE TO RELATED APPLICATIONS

This disclosure is a bypass continuation application of International Application No. PCT/CN2025/070245 filed on Jan. 2, 2025, which claims the benefit of and priority to Chinese Patent Application No. 2024100127186, entitled “MEASUREMENT INFORMATION REPORTING METHOD AND APPARATUS, TERMINAL, AND READABLE STORAGE MEDIUM” filed on Jan. 2, 2024, the contents of both of which are incorporated by reference in their entireties herein.

### TECHNICAL FIELD

This application relates to the field of communication technologies and, in particular, to a measurement information reporting method and apparatus, a terminal, and a readable storage medium.

### BACKGROUND

In future wireless communication systems, user equipment (UE) may perform measurements over a wider bandwidth using analog beams and may report the measurement results. Currently, analog beams are typically generated using phased-array antennas.

### SUMMARY

Embodiments of this application provide a measurement information reporting method and apparatus, a terminal, and a readable storage medium.

According to a first aspect, a measurement information reporting method is provided, including:
sending, by a terminal, target information to a network side device,
where the target information includes at least one of the following:
a target measurement resource index;
a target measurement value, where the target measurement value includes at least one of a sub-band measurement value and a wideband measurement value; and
antenna characteristic information of the terminal.

According to a second aspect, a measurement information reporting apparatus is provided, including:
a sending module, configured for a terminal to send target information to a network side device,

The target information includes at least one of the following:
a target measurement resource index;
a target measurement value, where the target measurement value includes at least one of a sub-band measurement value and a wideband measurement value; and
antenna characteristic information of the terminal.

According to a third aspect, a terminal is provided. The terminal includes a processor and a memory. The memory stores a program or instructions executable in the processor. The program or the instructions, when executed, cause the processor to implement the steps of the method according to the first aspect.

According to a fourth aspect, a terminal is provided, including a processor and a communication interface, where the communication interface is configured for the terminal to send target information to a network side device.

The target information includes at least one of the following:
a target measurement resource index;
a target measurement value, where the target measurement value includes at least one of a sub-band measurement value and a wideband measurement value; and
antenna characteristic information of the terminal.

According to a fifth aspect, a readable storage medium is provided. The readable storage medium stores a program or instructions, and when the program or the instructions are executed by a processor, the steps of the method according to the first aspect are implemented.

According to a sixth aspect, a wireless communication system is provided, including a terminal and a network side device. The terminal may be configured to perform the steps of the method according to the first aspect.

According to a seventh aspect, a chip is provided. The chip includes a processor and a communication interface. The communication interface is coupled to the processor. The processor is configured to run a program or instructions to implement the method according to the first aspect.

According to an eighth aspect, a computer program/program product is provided. The computer program/program product is stored in a storage medium, and the program/program product is executed by at least one processor to implement the method according to the first aspect.

### BRIEF DESCRIPTION OF THE DRAWINGS

FIG. 1a is a block diagram of a wireless communication system applicable to an embodiment of this application;

FIG. 1b is a schematic diagram of beam squint;

FIG. 2 is a schematic flowchart of a measurement information reporting method according to an embodiment of this application;

FIG. 3a is a first schematic diagram of an application scenario according to an embodiment of this application;

FIG. 3b is a first schematic diagram of an application scenario according to an embodiment of this application;

FIG. 3c is a first schematic diagram of an application scenario according to an embodiment of this application;

FIG. 3d is a first schematic diagram of an application scenario according to an embodiment of this application;

FIG. 4 is a schematic structural diagram of a measurement information reporting apparatus according to an embodiment of this application;

FIG. 5 is a schematic structural diagram of a communication device according to an embodiment of this application; and

FIG. 6 is a schematic structural diagram of a terminal according to an embodiment of this application.

### DETAILED DESCRIPTION

Technical solutions in embodiments of this application are clearly described below with reference to accompanying drawings in embodiments of this application. Understandably, the described embodiments are merely some rather than all embodiments of this application. All other embodiments obtained by a person of ordinary skill in the art based on embodiments of this application fall within the protection scope of this application.

Terms “first”, “second”, and the like in this application are used to distinguish between similar objects, rather than describing a specific order or sequence. It should be understood that the terms used in this way may be transposed where appropriate, so that embodiments of this application can be implemented in a sequence other than those illustrated or described herein. In addition, objects defined by “first” and “second” are generally of the same class and do not limit a quantity of objects. For example, one or more first objects may be arranged. In addition, “or” in this application indicates at least one of connected objects. For example, “A or B” covers three schemes: solution 1: A is included, but B is not included; solution 2: B is included and A is not included; and solution 3: both A and B are included. The character “/” generally indicates an “or” relationship between associated objects.

The term “indication” in this application may be a direct indication (or an explicit indication) or an indirect indication (or an implicit indication). An explicit indication may be understood as that a sending party explicitly notifies a receiving party of content such as specific information, an operation that needs to be performed, or a request result in the sent indication. An implicit indication may be understood as that the receiving party determines corresponding information based on an indication sent by the sending party, or performs determining and determines an operation that needs to be performed or a request result based on a determining result.

It should be noted that the technology described in embodiments of this application may be applied to a long term evolution (LTE)/LTE-advanced (LTE-A) system, and may be further applied to another wireless communication system, such as a code division multiple access (CDMA) system, a time division multiple access (TDMA) system, a frequency division multiple access (FDMA) system, an orthogonal frequency division multiple access (OFDMA) system, a single-carrier frequency-division multiple access (SC-FDMA) system, or another system. The terms “system” and “network” in embodiments of this application are often used interchangeably, and the described technology can be applied to the systems and radio technologies mentioned above, and can also be applied to other systems and radio technologies. A new radio (NR) system is described below as an example, and the term NR is used in most of the following description. However, the technologies may also be applied to systems other than the NR system, such as a 6th generation (6G) communication system.

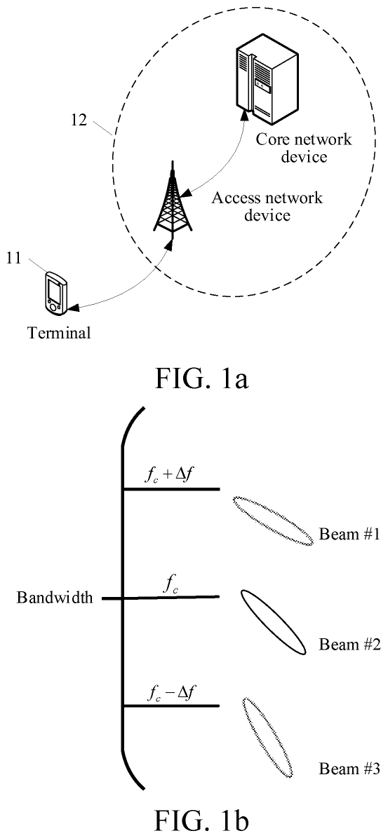

FIG. 1a is a block diagram showing a wireless communication system applicable to an embodiment of this application. The wireless communication system includes a terminal 11 and a network side device 12. The terminal 11 may be a terminal side device such as a mobile phone, a tablet personal computer, a laptop computer, a notebook computer, a personal digital assistant (PDA), a palmtop computer, a netbook, an ultra-mobile personal computer (UMPC), a mobile internet device (MID), an augmented reality (AR) or virtual reality (VR) device, a robot, a wearable device, a flight vehicle, an on-board device (Vehicle User Equipment, VUE), a ship-borne device, a pedestrian user equipment (PUE), a smart home appliance (a home device with a wireless communication capability, such as a refrigerator, a television, a washing machine, or furniture), a game console, a personal computer (PC), a teller machine, or a self-service machine. The wearable device includes a smart watch, a smart bracelet, a smart headset, smart glasses, smart jewelry (a smart bracelet, a smart chain bracelet, a smart ring, a smart necklace, a smart ankle bangle, a smart ankle chain, and the like), a smart wristband, smart clothing, and the like. The on-board device may also be referred to as an on-board terminal, an on-board controller, an on-board module, an on-board component, an on-board chip, an on-board unit, or the like. It should be noted that a specific type of the terminal 11 is not limited in embodiments of this application. The network side device 12 may include an access network device or a core network device. The access network device may also be referred to as a radio access network (RAN) device, a wireless access network function, or a wireless access network unit. The access network device may include a base station, a wireless local area network (WLAN) Access Point (AP), a Wireless Fidelity (Wi-Fi) node, or the like. The base station may be referred to as a node B (NB), an evolved Node B (Evolved Node B, eNB), a next generation Node B (the next generation Node B, gNB), a new radio Node B (New Radio Node B, NR Node B), an access point, a relay base station (RBS), a serving base station (SBS), a base transceiver station (BTS), a radio base station, a radio transceiver, a basic service set (BSS), an extended service set (ESS), a home node B (HNB), a home evolved node B, a transmission reception point (TRP), or another appropriate term in the art. The base station is not limited to a specific technical term, as long as the same technical effect can be achieved. It should be noted that, in embodiments of this application, a base station in an NR system is merely used as an example, and a specific type of the base station is not limited.

The core network device may include the core network device may include, but is not limited to, at least one of the following: a core network node, a core network function, a mobility management entity (MME), an access and mobility management function (AMF), a session management function (SMF), a user plane function (UPF), a policy control function (PCF), a policy and charging rules function (PCRF), an edge application server discovery function (EASDF), unified data management (UDM), a unified data repository (UDR), a home subscriber server (HSS), a centralized network configuration (CNC), a network repository function (NRF), a network exposure function (NEF), a local NEF (Local NEF, or L-NEF), a binding support function (BSF), an application function (AF), and the like. It should be noted that in embodiments of this application, only a core network device in the NR system is used as an example, but the specific type of the core network device is not limited.

To better understand the technical solutions of this application, the following content is first described.

A phased array antenna achieves spatial filtering through phase compensation, and one of basic assumptions is that a received or sent signal is in a sub-band, namely, a bandwidth/a carrier frequency being much less than 1. When the assumption is not satisfied, beam squint occurs. The beam squint means that beams on two sides of a bandwidth deviate from a beam corresponding to a center frequency, as shown in FIG. 1b.

A beam-squint angle, namely, an angle difference between beam #1 and beam #2, may be represented as:

$$Δ θ = arcsin ( \frac{sin ( {θ}_{1} ) {f}_{c}}{f 2} ) - {θ}_{1} = arcsin ( \frac{sin ( {θ}_{1} ) {f}_{c}}{{f}_{c} + Δ f} ) - {θ}_{1}$$

where f_{c} is a frequency of a central carrier frequency, f₂ is an operation carrier frequency, and θ₁ is a beam indication angle of the central carrier frequency. It can be known based on the foregoing equation that the beam obliquity angle is related to the carrier frequency difference and the beam indication angle of the central carrier frequency.

### Beam Measurement and Reporting

Analog beamforming is intended for full-bandwidth transmission, and an array element on a panel of each high-frequency antenna array in each polarization direction can only send an analog beam in a time division multiplexing manner. A beamforming weight for the analog beam is implemented by adjusting a parameter of a device, such as a radio frequency front-end phase shifter.

Currently, in an academic community and in industry, an analog beamforming vector is usually trained through polling. In other words, array elements in each polarization direction of each antenna panel sequentially send training signals (that is, candidate shaping vectors) in a time division multiplexing manner at an appointed time, a terminal feeds back a beam report after measurement, and this training signal is used by a network side in a next transmission service to implement analog beam transmission.

### Beam Measurement

Current standards only support performing beam measurement through a channel state information reference signal (CSI-RS) or a synchronization signal block (Synchronization Signal/PBCH Block, SSB), and the CSI-RS for beam measurement has only 1 port to 2 ports. The SSB is a periodic reference signal. However, the CSI-RS for beam measurement may be periodic, semi-persistent, or aperiodic.

The beam measurement supports L1 beam measurement on an asynchronous inter-frequency neighboring cell under a mobility enhancement project, and both currently support only SSB-based L1-RSRP measurement. After performing the L1 beam measurement based on a measurement resource configured by a network, a terminal selects, based on a measurement result, some beams for reporting.

### Beam Reporting

In the current standards, a terminal selects an appropriate beam for reporting based on a full-bandwidth beam measurement result. A measurement quantity for full-bandwidth beam measurement may be L1-reference signal receiving power (L1-RSRP)/L1-reference signal received quality (L1-RSRQ)/L1-Signal Interference Noise Ratio (L1-SINR), and beam reporting manners include a group-based manner and a non-group-based manner. For non-group-based beam reporting, the terminal selects, based on a measurement quantity, at most 4 beams for reporting from all measurement resources configured at the network side. For group-based beam reporting, the terminal selects a pair of beams that can be simultaneously received by UE for reporting based on a measurement result. Reported content includes a measurement resource index and a measurement value corresponding to the measurement resource index, and the measurement resource index CRI/SSBRI is an index of the measurement resource in a measurement resource set (NZP-CSI-RS-ResourceSet or CSI-SSB-ResourceSet) corresponding to the measurement resource index.

In a multi-transmission receiving node project, the group-based beam reporting manner is enhanced. The terminal optionally reports, from measurement resources configured by a network, a beam that can be simultaneously received by up to 4 pairs of UE, and different beams in each pair of simultaneously received beams correspond to different transmission receiving nodes, thereby ensuring that the pair of beams can be sent simultaneously through the network.

In an L1/L2-Triggered Mobility (LTM for short) project, L1 reporting for switching, namely, ltm-CSI-ReportConfig, is introduced. In an L1 report for switching, the terminal can perform reporting on 4 cells at most, and each cell reports 4 beam measurement results, namely, at most 16 beams and measurement results corresponding thereto.

In a 6G system, as a bandwidth increases, beam squint becomes worse. However, the current standards support only wideband beam reporting, and the following problems exist:
Optimal beams corresponding to different carrier frequencies cannot be effectively fed back at a base station side, so that a beam used by a base station during sub-band scheduling may not be an optimal one, thereby degrading transmission performance; and
a base station cannot acquire a beam squint characteristic on a UE side, leading to a selected beam pair that may not be an optimal beam pair.

This application provides a measurement information reporting method.

The measurement information reporting method provided in embodiments of this application is described below through some embodiments and application scenarios thereof with reference to the accompanying drawings.

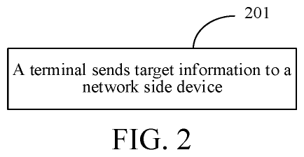

Referring to FIG. 2, an embodiment of this application provides a measurement information reporting method. The method is performed by a terminal. The method includes the following steps:
Step 201: A terminal sends target information to a network side device.

The target information includes at least one of the following:
(1) Target measurement resource index;
The target measurement resource index may include at least one of an absolute index or a differential index, and may be specifically represented as resource hop id/Resource Id/Resource Set id/Resource Setting id. The absolute index refers to a resource index of the target measurement resource in a measurement resource set to which the target measurement resource belongs, or a measurement resource configuration, or a BWP, or a cell. The differential index refers to a bias value between an absolute index of the target measurement resource and an absolute index of a reference measurement resource. The reference measurement resource is determined by a terminal, or indicated by a network configuration, or specified according to a protocol.
(2) Target measurement value, including at least one of a sub-band measurement value and a wideband measurement value; A specific measurement value may be L1-RSRP/L1-SINR/L1-RSRQ. Sub-band measurement values refer to measurement values of at least some frequency domain resources corresponding to a target measurement resource, and wideband measurement values refer to measurement values of all frequency domain resources corresponding to the target measurement resource.
(3) Antenna characteristic information of the terminal, which including, but not limited to, the number of antenna ports, the number of antenna elements, a tilt of an antenna panel, an angle of a first receive beam for a terminal, and an angle of a first transmitting beam for the terminal.

The terminal reports the number of antenna ports, the number of antenna elements, and the angle at which the terminal receives or sends a beam to a network side, and the network can perform an operation based on the above features to reduce an impact of beam squint (if existing) on the terminal side.

In embodiments of this application, the terminal sends the target information to the network side device. The target information includes at least one of the following: a target measurement resource index including at least one of an absolute index and a differential index; a target measurement value, including at least one of a sub-band measurement value and a wideband measurement value; and antenna characteristic information of the terminal. In this way, for a beam squint problem in a high-frequency-band large-bandwidth scenario, an optimal beam and a beam squint feature are effectively fed back to a network side based on wideband and narrowband beam measurement and terminal characteristic reporting, thereby improving flexibility and accuracy for a beam selection during subsequent scheduling on a network side.

In a possible implementation, before the terminal sends the target information to the network side device, the method further includes:

determining, by the terminal, target information through first measurement based on first measurement resource configuration information.

In a possible implementation, the first measurement resource configuration information includes at least one of the following:
(1) information about one or a plurality of first measurement resources, where the first measurement resource is a wideband measurement resource, transmitting beams for the plurality of first measurement resources are different or the same, and may correspond to a legacy or Rx hopping solution for a wideband CSI-RS. The transmitting beams for the plurality of first measurement resources are different, or transmitting beams for the plurality of first measurement resources that have an association relationship are the same. In other words, in a case that a plurality of first measurement resources are configured by a network, transmitting beams for the first measurement resources are different, or transmitting beams for the plurality of first measurement resources, configured by a network, that have an association relationship are the same. For example, a configured measurement resource is a wideband RS. A measurement configuration or a reporting configuration indicates a terminal to perform measurement on sub-band Rx hopping, where a configuration related to the sub-band Rx hopping (for example, a numeral M of sub-band Rx hopping and a sub-band bandwidth) is configured or indicated by a network. Alternatively, the wideband RS resources are subjected to resource set or subset division by using M as a unit, and transmitting beams for RS resources in the same set or subset are the same. Further, the RS resources in the same set or subset are consecutive in a time domain.
(2) information about one or a plurality of second measurement resources, where each of the second measurement resources includes a plurality of sub-band measurement resources having an association relationship, and transmitting beams for a plurality of sub-band measurement resources having an association relationship are the same or different, and may correspond to a solution in which a CSI-RS is subjected to hopping in a resource. The association relationship may be configured or indicated by a network, or stipulated by a protocol, or determined by a terminal based on a default rule. transmitting beams for a sub-band measurement resource in each of the second measurement resources are the same, and transmitting beams for sub-band measurement resources in different second measurement resources are different. For example, three second measurement resources, A, B, and C are configured, transmitting beams for sub-band measurement resources in A are first beams, transmitting beams for sub-band measurement resources in B are second beams, and transmitting beams for sub-band measurement resources in C are third beams.

Alternatively, the transmitting beams for the sub-band measurement resources in each second measurement resource are different, and the transmitting beams of the sub-band measurement resources in different second measurement resources are the same. For example, three second measurement resources, A, B, and C are configured, transmitting beams for sub-band measurement resources in A are a first beam, a second beam, and a third beam, transmitting beams for sub-band measurement resources in B are the first beam, the second beam, and the third beam, and transmitting beams for sub-band measurement resources in C are the first beam, the second beam, and the third beam.
(3) information about one or a plurality of third measurement resource sets, where measurement resources in the third measurement resource sets are a sub-band measurement resource, and transmitting beams for the measurement resource in the third measurement resource set are the same or different, and may correspond to a solution in which a CSI-RS is subjected to hopping in a resource set. transmitting beams for measurement resources in each of the third measurement resource sets are the same, and transmitting beams for measurement resources in different third measurement resource sets are different. For example, three third measurement resource sets A, B, and C are configured, transmitting beams for measurement resources in A are first beams, transmitting beams for measurement resources in B are second beams, and transmitting beams for measurement resources in C are third beams.

Alternatively, the transmitting beams for the measurement resources in each of the third measurement resource sets are different, and the transmitting beams for the measurement resources in different third measurement resource sets are the same. For example, three third measurement resource sets A, B, and C are configured, transmitting beams for measurement resources in A are a first beam, a second beam, and a third beam, transmitting beams for measurement resources in B are the first beam, the second beam, and the third beam, and transmitting beams for measurement resources in C are the first beam, the second beam, and the third beam.

It should be noted that the beams being different described above may specifically mean beam angles being different. “A plurality of” described throughout this application refers to two or more.

Specifically, the transmitting beams, the beams, the beam angles, and the like may be represented through manners, such as a transmission configuration indication state (Transmission configuration indication state, TCI state), a quasi-colocation assumption, a space relationship, and a transmission configuration indication uplink state (Transmission configuration indication state uplink state, TCI-UL-State).

In a possible implementation, the first measurement includes at least one of the following:
(1) determining, by the terminal, at least one of a wideband measurement value and N1 sub-band measurement values of a first measurement resource based on information about a first measurement resource, where N1 is greater than or equal to 1;
(2) determining, by the terminal based on information about a second measurement resource, at least one of a wideband measurement value and sub-band measurement values corresponding to N2 sub-band measurement resources of the second measurement resource, where N2 is greater than or equal to 1;
(3) determining, by the terminal based on information about a third measurement resource set, at least one of: a measurement value of a wideband measurement resource corresponding to the third measurement resource set, and a sub-band measurement value corresponding to N3 sub-band measurement resources, where N3 is greater than or equal to 1.

Values of N1, N2, and N3 may be configured or indicated by a network, or determined by the terminal itself. Further, when the values of N1, N2, and N3 are determined by the terminal, the terminal needs to notify the network of the values of N1, N2, and N3. Specifically, the values of N1, N2, and N3 may be reported as target information, or may be reported as individual information.

In a possible implementation, the terminal determines an operation behavior for the first measurement based on at least one of the following manners:
(a) being configured or indicated by a network;
(b) being specified in a protocol; and
(c) being determined by the terminal.

In other words, for the operation behaviors of (1) to (3) included in the first measurement, one of the operation behaviors or a combination of several operation behaviors in the operation behaviors to be specifically used may be configured or indicated by the network, or may be specified according to a default rule of a protocol, or may be determined by the terminal. Specifically, in the operation behavior for the first measurement, the operation behavior by the terminal to obtain only a wideband measurement value, or to obtain only a sub-band measurement value, or to obtain the two may be configured or indicated by the network, or specified according to the default rule of the protocol, or determined by the terminal.

In a possible implementation, the determining the target information through the first measurement includes:
determining, by the terminal, the target information according to a first rule after performing the first measurement.

The first rule includes at least one of the following:
(1) the terminal determines that the target measurement value as a wideband measurement value, selects one or more target measurement resources based on a wideband measurement result, and determines a target measurement resource index as a first measurement resource index, or a second measurement resource index, or a third measurement resource set index based on the target measurement resource;
if the target measurement resource is a first measurement resource, the target measurement resource index is a first measurement resource index, if the target measurement resource is a second measurement resource, the target measurement resource index is a second measurement resource index, and if the target measurement resource is a third measurement resource, the target measurement resource index is a third measurement resource set index.
(2) the terminal determines the target measurement value as the sub-band measurement value, selects one or more target measurement resources based on the sub-band measurement result, and determines target measurement resource index according to a second rule.
(3) the terminal determines that the target measurement value includes the wideband measurement value and the sub-band measurement value and selects one or more target measurement resources based on the wideband measurement result or the sub-band measurement result, and in addition to the wideband measurement value of the target measurement resource, the target measurement value in the target information further includes N4 sub-band measurement values corresponding to the target measurement resource; and the target information includes at least one target resource index, and the target resource index is at least one of the first measurement resource index, the second measurement resource index, the third measurement resource set index, and a third measurement resource index. N4 is greater than or equal to 1.

In a possible implementation, the first rule is configured or indicated by a network, or is specified according to a default rule of a protocol, or is determined by the terminal.

In other words, for (1) to (3) included in the first rule, one of (1) to (3) or a combination of several items of (1) to (3) to be specifically used may be configured or indicated by the network, or may be specified according to the default rule of the protocol, or may be determined by the terminal.

In a possible implementation, when the first rule is that the terminal determines the target measurement value as the wideband measurement value, selects one or more target measurement resources based on the wideband measurement result, and determines the target measurement resource index as the first measurement resource index, the second measurement resource index, or the third measurement resource set index based on the target measurement resource, the first rule further includes:
when the target measurement resource meets a first condition, the terminal determines that the target measurement value further includes a measurement value corresponding to a fourth measurement resource, and that the target measurement resource index further includes a resource index corresponding to the fourth measurement resource.

The first condition includes at least one of the following:
(1) the target measurement resource is associated with a fifth measurement resource set;
(2) a first high-layer parameter is included in configuration information of the target measurement resource;
(3) the first high-layer parameter is included in the configuration information of the target measurement resource, and the first high-layer parameter is set to “enabled”; and
(4) a bit mapping corresponding to the target measurement resource is a preset value, and a sequence length of the bit mapping is the number of measurement resources in a measurement resource set to which the target measurement resource belongs. The preset value may be 1 or 0. In a possible implementation, the fourth measurement resource has a first spatial relationship with the target measurement resource, and the first spatial relationship satisfies at least one of the following:
(1) adjacent measurement resource indexes; for example, where NZP CSI-RS resource #2 and NZP CSI-RS resource #4 have an adjacent spatial relationship with NZP CSI-RS resource #3;
(2) having a quasi co-location (Quasi Co Location, QCL) relationship; where if a QCL source RS of the NZP CSI-RS resource #3 is NZP CSI-RS resource #5, a fourth measurement resource is the NZP CSI-RS resource #5; and
(3) being configured by a network. For example, the network configures that a fourth measurement resource corresponding to the NZP CSI-RS resource #3 is the NZP CSI-RS resource #2 and the NZP CSI-RS resource #4.

The network configures multiple measurement resources, different measurement resources may correspond to different beam transmission angles, and the terminal performs wideband beam measurement and reporting. If a beam transmission angle for a measurement resource corresponding to a first measurement result causes an offset in a beam for an edge bandwidth, the terminal reports a measurement resource (namely, the fourth measurement resource) corresponding to a neighboring beam thereof in addition to the measurement resource corresponding to the first measurement result. Otherwise, the terminal reports only the measurement resource corresponding to the first measurement result, to reflect a beam squint phenomenon to a network side and report a minimized overhead.

In a possible implementation, the determining the target information through the first measurement includes:
determining, by the terminal, the target information based on a third rule when the number of target measurement resource indexes or the number of target measurement values that is determined through the first measurement is greater than 1.

The third rule includes at least one of the following:
(1) except that a target measurement resource index corresponding to a first target measurement resource serves as a resource index corresponding to the first target measurement resource, target measurement resource indexes of remaining target measurement resources are determined in a differential manner; and the differential difference manner may be understood as target measurement resource indexes of remaining target measurement resources being offset values between absolute indexes of the target measurement resources and absolute indexes of the first target measurement resources;
(2) except that a target measurement value corresponding to the first target measurement resource serves as a measurement value corresponding to the first target measurement resource, target measurement values of remaining target measurement resources are determined in a differential manner; and the specific differential manner may be understood as the target measurement values of the remaining target measurement resources being offset values between a measurement value of the target measurement resource and a measurement value of the first target measurement resource; and
(3) when a plurality of target measurement resource indexes are the same in the target information, only one target measurement resource index in the plurality of target measurement resource indexes and a target measurement value corresponding to the target measurement resource are reported.

It may be understood that if the number of target measurement resource indexes or the number of target measurement values determined through the first measurement is not greater than 1, the target information is determined based on the first measurement.

A network configures multiple measurement resources, and a terminal performs sub-band beam measurement and reporting. In other words, an optimal beam is selected by using a sub-band as a unit, and differential reporting is performed by using a CRI to reduce reporting overheads.

In a possible implementation, the method further includes:
determining, by the terminal, the first target measurement resource through at least one of the following manners:
(1) a target measurement resource with the maximum target measurement value;
(2) a minimum or maximum index in all target measurement resources; and
(3) being configured or indicated by a network.

The technical solutions of this application are described below with reference to specific application embodiments.

### Embodiment 1: Wideband RS-Based Beam Measurement and Reporting

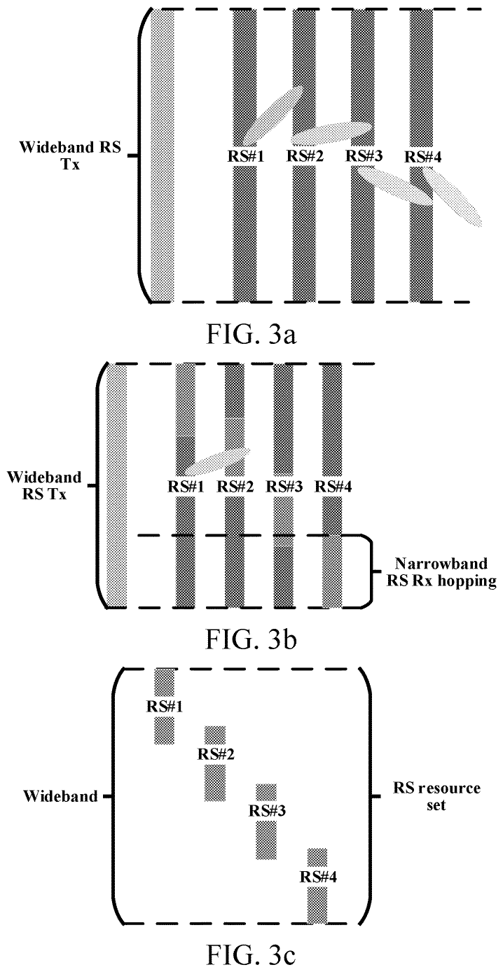

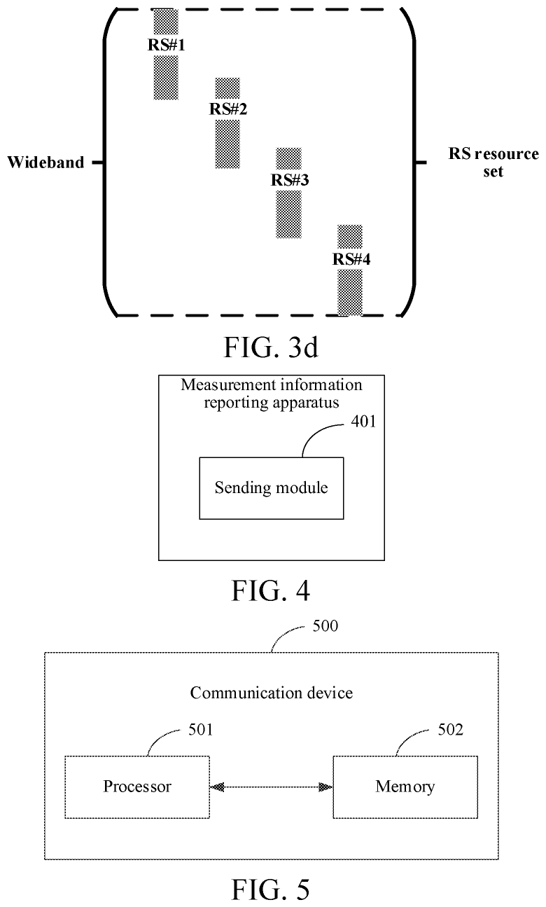

### Refer to FIG. 3a.

Step-1: A terminal receives configuration information of a network side, which includes, but is not limited to, reporting configuration information and measurement configuration information, where a measurement resource configured in the measurement configuration is a wideband RS, and beams for different RSs may be different or the same.

Step-2: Perform step-3a when it is indicated in the measurement configuration that a measurement quantity is a wideband measurement quantity, or it is indicated in the reporting configuration that a reporting measurement quantity is the wideband measurement quantity; and perform step-3b when it is indicated in the measurement configuration that the measurement quantity is a sub-band measurement quantity, or it is indicated in the reporting configuration that the reporting measurement quantity is a sub-band measurement quantity; and perform step-3c when it is indicated in the measurement configuration that the measurement quantities are wideband and sub-band measurement quantities, or it is indicated in the reporting configuration that the reporting measurement quantities are the wideband and sub-band measurement quantities.

### Step-3a:

The terminal performs measurement by using an RS bandwidth as a unit to obtain a wideband measurement value;
the terminal selects N (N≥1) first RSs for reporting based on the wideband measurement value, and when at least one first RS of the N first RSs satisfies a first condition (see the foregoing related description), for each first RS that satisfies the condition, the terminal further selects n (n≥1) fourth RSs (namely, fourth measurement resources, see the foregoing related description) for reporting. Values of N and n are configured or indicated by a network, or specified in a protocol.

The N first RSs are N RSs having a largest wideband measurement value. the foregoing information may be divided into two parts for transmission, where resource indexes and measurement values of the N first RSs may be referred to as a first part, and resource indexes and/or measurement values of n fourth RSs corresponding to first RSs, in the N first RSs, that meet a first condition may be referred to as a second part; a bit length of the second part may be determined based on the first part, and a priority of the first part is higher than that of the second part; and
when a value of N+n is greater than 1, the terminal performs differential reporting for a measurement resource index and differential reporting for a measurement value.

### Step-3b:

The terminal performs measurement in a sub-band of an RS bandwidth as a unit to obtain a sub-band measurement quantity, where a sub-band-related configuration (for example, the number of sub-bands within the RS bandwidth and a sub-band bandwidth) is configured or indicated by a network;
the terminal selects N (N≥1) largest sub-band measurement values and RS indexes corresponding thereto for reporting based on sub-band measurement values, where a value of N is configured or indicated by a network, or specified in a protocol; or selects, in each sub-band, n (n≥1) second RSs that have largest measurement values in the sub-band and RS indexes corresponding thereto for reporting; or values of N and n are configured or indicated by a network, or specified in a protocol.

When the value of Nis greater than 1 or a value of (the number of sub-bands*n) is greater than 1, the terminal performs differential reporting for a measurement resource index and differential reporting for a measurement value, and/or the terminal selects only different measurement resource indexes and measurement values thereof.

### Step-3c:

The terminal performs measurement by using the RS bandwidth and the sub-band of the RS bandwidth as units, where one wideband measurement value and multiple sub-band measurement values may be obtained for an RS occasion, where a sub-band-related configuration (for example, the number of sub-bands within the RS bandwidth and a sub-band bandwidth) is configured or indicated by a network.

The terminal selects N (N≥1) first RSs for reporting based on the wideband measurement value, and when at least one first RS of the N first RSs satisfies a first condition, for each first RS that satisfies the condition, the terminal further selects n (n≥1) fourth RSs for reporting. values of N and n are configured or indicated by a network, or specified in a protocol.
the N first RSs are N RSs having a largest wideband measurement value;
the foregoing information may be divided into two parts for transmission, where resource indexes and measurement values of the N first RSs may be referred to as a first part, and resource indexes and/or measurement values of n fourth RSs corresponding to first RSs, in the N first RSs, that meet a first condition may be referred to as a second part; a bit length of the second part may be determined based on the first part, and a priority of the first part is higher than that of the second part;
when a value of N+n is greater than 1, the terminal performs differential reporting for a measurement resource index and differential reporting for a measurement value; and
for the N first RSs, a sub-band measurement value is also reported in addition to the wideband measurement value, where the sub-band measurement value and the wideband measurement value are reported through differential reporting.

### Embodiment 2: Beam Measurement and Reporting Performed on Sub-Band RS Rx Hopping Based on a Wideband RS

Refer to FIG. 3b.

Step-1: The terminal receives configuration information on a network side, including but not limited to reporting configuration information and measurement configuration information, where a measurement resource configured in the measurement configuration is a wideband RS, the measurement configuration or the reporting configuration indicates the terminal to perform measurement on sub-band Rx hopping, and a configuration related to the sub-band Rx hopping (for example, the number M of pieces of sub-band Rx hopping and a sub-band bandwidth) is configured or indicated by a network. Alternatively, the wideband RS resources are subjected to resource set or subset division by using M as a unit, and transmitting beams for RS resources in the same set or subset are the same. Further, the RS resources in the same set or subset are consecutive in a time domain.

Step-2: The terminal performs measurement by using an RX hopping bandwidth of a sub-band RS as a unit to obtain sub-band measurement values; and step-3 is performed.

### Step-3:

The terminal selects, in each sub-band based on the sub-band measurement values, n (n≥1) second RSs having a largest measurement value in the sub-band and RS indexes corresponding thereto for reporting. A value of n is configured or indicated by a network, or specified in a protocol.

When a value of M*n is greater than 1, the terminal performs differential reporting for a measurement resource index and differential reporting for a measurement value, and/or the terminal selects only different measurement resource indexes and measurement values thereof.

### Embodiment 3: Beam Measurement and Reporting Based on Hopping within an RS Resource

Refer to FIG. 3c.

Step-1: The terminal receives the configuration information on the network side, including, but not limited to, the reporting configuration information and the measurement configuration information, where the measurement resource configured in the measurement configuration is a wideband RS, the wideband CSI-RS includes M Tx hops, and configuration related to sub-band Tx hopping (for example, a quantity M of pieces of sub-band Tx hopping and a sub-band bandwidth) is configured or indicated by a network. Alternatively, transmitting beams for different hops for a wideband RS resource are the same, and transmitting beams for different wideband RS resources may be the same or different.

Step-2: The terminal performs measurement with a Tx hop bandwidth as a unit to obtain sub-band measurement values; and step-3 is performed.

### Step-3:

The terminal selects, in each sub-band based on the sub-band measurement values, n (n≥1) second RSs having a largest measurement value in the sub-band and RS indexes corresponding thereto for reporting. A value of n is configured or indicated by a network, or specified in a protocol.

When a value of M*n is greater than 1, the terminal performs differential reporting for a measurement resource index and differential reporting for a measurement value, and/or the terminal selects only different measurement resource indexes and measurement values thereof.

### Embodiment 4: Beam Measurement and Reporting Based on Hopping within an RS Resource Set

Refer to FIG. 3d.

Step-1: The terminal receives configuration information on a network side, including, but not limited to, reporting configuration information and measurement configuration information, measurement resources configured in the measurement configuration are sub-band RSs, different RSs in an RS resource set correspond to different frequency domain resources, and frequency domain resources corresponding to all RS resources in the RS resource set are equal to a wideband bandwidth. The number of RSs in the RS resource set is configured or indicated by a network. Alternatively, transmitting beams for RSs in the RS resource set are the same, and transmitting beams for RSs in different RS resource sets may be the same or different.

Step-2: The terminal performs measurement by using an RS bandwidth as a unit to obtain sub-band measurement values; and step-3 is performed.

### Step-3:

The terminal selects, in each sub-band based on the sub-band measurement values, n (n≥1) second RSs having a largest measurement value in the sub-band and RS indexes corresponding thereto for reporting. A value of n is configured or indicated by a network, or specified in a protocol.

When a value of M*n is greater than 1, the terminal performs differential reporting for a measurement resource index and differential reporting for a measurement value, and/or the terminal selects only different measurement resource indexes and measurement values thereof.

The measurement information reporting method according to embodiments of this application may be executed by a measurement information reporting apparatus. In embodiments of this application, an example in which the measurement information reporting apparatus performs the measurement information reporting method is used to describe the measurement information reporting apparatus provided in embodiments of this application.

Refer to FIG. 4. An embodiment of this application provides a measurement information reporting apparatus. The apparatus may be applied to a terminal. The apparatus includes:
a sending module 401, configured for a terminal to send target information to a network side device,

The target information includes at least one of the following:
a target measurement resource index;
a target measurement value, where the target measurement value includes at least one of a sub-band measurement value and a wideband measurement value; and
antenna characteristic information of the terminal.

Alternatively, the apparatus further includes:
a first determining module, configured to determine the target information through first measurement by the terminal based on first measurement resource configuration information before the terminal sends the target information to the network side device.

Alternatively, the first measurement resource configuration information includes at least one of the following:
information about one or a plurality of first measurement resources, where the first measurement resource is a wideband measurement resource, transmitting beams for the plurality of first measurement resources are different, or transmitting beams for the plurality of first measurement resources having an association relationship are the same;
information about one or a plurality of second measurement resources, where each of the second measurement resources includes a plurality of sub-band measurement resources having an association relationship, transmitting beams for sub-band measurement resources in each of the second measurement resources are the same, and transmitting beams for sub-band measurement resources in different second measurement resources are different, or transmitting beams for the sub-band measurement resources in each of the second measurement resources are different, and transmitting beams for the sub-band measurement resources in different second measurement resources are the same; and
information about one or a plurality of third measurement resource sets, where measurement resources in the third measurement resource sets are sub-band measurement resources, transmitting beams for measurement resources in each of the third measurement resource sets are the same, and transmitting beams for measurement resources in different third measurement resource sets are different, or transmitting beams for measurement resources in each of the third measurement resource sets are different, and transmitting beams for measurement resources in different third measurement resource sets are the same.

Alternatively, the first measurement includes at least one of the following:
determining, by the terminal, at least one of a wideband measurement value and N1 sub-band measurement values of the first measurement resource based on the information about the first measurement resource;
determining, by the terminal based on the information about the second measurement resource, at least one of a wideband measurement value and sub-band measurement values corresponding to N2 sub-band measurement resources of the second measurement resource; and
determining, by the terminal based on the information about the third measurement resource set, at least one of: a measurement value of a wideband measurement resource corresponding to the third measurement resource set, and sub-band measurement values corresponding to N3 sub-band measurement resources.

Alternatively, the terminal determines an operation behavior for the first measurement based on at least one of the following manners:
being configured or indicated by a network;
being specified in a protocol; and
being determined by the terminal.

Alternatively, the first determining module is specifically configured to:
determine, by the terminal, the target information according to a first rule after performing the first measurement; and
the first rule includes at least one of the following:
the terminal determines the target measurement value as the wideband measurement value, selects one or more target measurement resources based on a wideband measurement result, and determines the target measurement resource index as a first measurement resource index, or a second measurement resource index, or a third measurement resource set index based on the target measurement resource;
the terminal determines the target measurement value as the sub-band measurement value, selects one or more target measurement resources based on the sub-band measurement result, and determines the target measurement resource index according to a second rule; and
the terminal determines that the target measurement value includes the wideband measurement value and the sub-band measurement value, and selects one or more target measurement resources based on the wideband measurement result or the sub-band measurement result, and in addition to the wideband measurement value of the target measurement resource, the target measurement value in the target information further includes N4 sub-band measurement values corresponding to the target measurement resource; and the target information includes at least one target resource index, and the target resource index is at least one of the first measurement resource index, the second measurement resource index, the third measurement resource set index, and a third measurement resource index.

Alternatively, the first rule is configured or indicated by a network, or specified according to a default rule of a protocol, or determined by the terminal.

Alternatively, when the first rule is that the terminal determines the target measurement value as the wideband measurement value, selects one or more target measurement resources based on the wideband measurement result, and determines the target measurement resource index as the first measurement resource index, the second measurement resource index, or the third measurement resource set index based on the target measurement resource, the first rule further includes:
when the target measurement resource meets a first condition, the terminal determines that the target measurement value further includes a measurement value corresponding to a fourth measurement resource, and that the target measurement resource index further includes a resource index corresponding to the fourth measurement resource; and
the first condition includes at least one of the following:
the target measurement resource is associated with a fifth measurement resource set;
a first high-layer parameter is included in configuration information of the target measurement resource;
the first high-layer parameter is included in the configuration information of the target measurement resource, and the first high-layer parameter is set to “enabled”; and
a bit mapping corresponding to the target measurement resource is a preset value, and a sequence length of the bit mapping is the number of measurement resources in a measurement resource set to which the target measurement resource belongs.

Alternatively, the fourth measurement resource has a first spatial relationship with the target measurement resource, and the first spatial relationship meets at least one of the following:
adjacent measurement resource indexes;
having a QCL relationship; and
being configured by a network.

Alternatively, the first determining module is specifically configured to:
determine the target information by the terminal according to a third rule when the number of target measurement resource indexes or the number of target measurement values that is determined through the first measurement is greater than 1, where
the third rule includes at least one of the following:
except that a target measurement resource index corresponding to a first target measurement resource serves as a resource index corresponding to the first target measurement resource, target measurement resource indexes of remaining target measurement resources are determined in a differential manner;
except that the target measurement value corresponding to the first target measurement resource serves as a measurement value corresponding to the first target measurement resource, target measurement values of remaining target measurement resources are determined in a differential manner; and
when a plurality of target measurement resource indexes are the same in the target information, only one target measurement resource index in the plurality of target measurement resource indexes and a target measurement value corresponding to the target measurement resource are reported.

Alternatively, the apparatus further includes:
a second determining module, configured to determine the first target measurement resource by the terminal through at least one of the following manners:
a target measurement resource with the maximum target measurement value;
a minimum or maximum index in all the target measurement resources; and being configured or indicated by a network.

The measurement information reporting apparatus in embodiments of this application may be an electronic device, for example, an electronic device having an operating system, or a component in an electronic device, for example, an integrated circuit or a chip. The electronic device may be a terminal or may be other devices other than the terminal. For example, the terminal may include, but is not limited to, the foregoing listed types of the terminal 11. The another device may be a server, a network attached storage (NAS), or the like, which is not specifically limited in embodiments of this application.

The measurement information reporting apparatus provided in embodiments of this application can implement each process implemented in the method embodiment of FIG. 2 to FIG. 3d, and achieve the same technical effect. To avoid repetition, details are not described herein again.

As shown in FIG. 5, an embodiment of this application further provides a communication device 500, including a processor 501 and a memory 502. The memory 502 stores a program or instructions executable in the processor 501. For example, when the communication device 500 is a terminal, the program or the instructions, when executed by the processor 501, implement the steps of the foregoing method embodiments, and can achieve the same technical effect. When the communication device m00 is a network side device, the program or the instructions, when executed by the processor 501, implement the steps in the foregoing method embodiments, and can achieve the same technical effect. To avoid repetition, details are not described herein again.

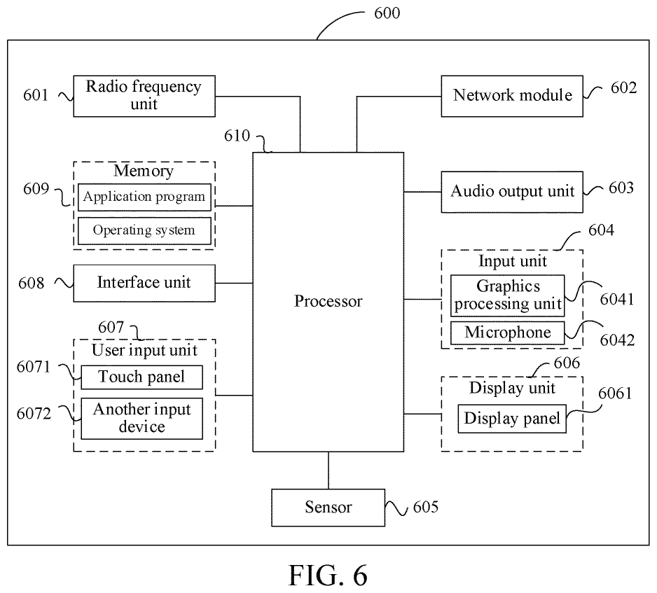

An embodiment of this application further provides a terminal, including a processor and a communication interface. The communication interface is coupled to the processor, and the processor is configured to run a program or instructions, to implement the steps of the method embodiments. The terminal embodiment corresponds to the foregoing method embodiment of the terminal side. The implementation processes and implementations of the foregoing method embodiments are all applicable to the terminal embodiment and can achieve the same technical effect. Specifically, FIG. 6 is a schematic diagram of a hardware structure of a terminal according to an embodiment of this application.

The terminal 600 includes, but is not limited to at least some of components such as a radio frequency unit 601, a network module 602, an audio output unit 603, an input unit 604, a sensor 605, a display unit 606, a user input unit 607, an interface unit 608, a memory 609, and a processor 610.

A person skilled in the art may understand that the terminal 600 may further include a power supply (for example, a battery) that supplies power to the components. The power supply may be logically connected to the processor 610 through a power supply management system, to implement functions such as charging and discharging management and power consumption management through the power supply management system. The terminal structure shown in FIG. 6 constitutes no limitation on the terminal, and the terminal may include more or fewer components than those shown in the figure, or some merged components, or different component arrangements. Details are not described herein again.

It should be understood that in embodiments of this application, the input unit 604 may include a graphics processing unit (GPU) 6041 and a microphone 6042. The graphics processing unit 6041 processes image data of a static picture or a video obtained by an image capturing apparatus (for example, a camera) in a video capturing mode or an image capturing mode. The display unit 606 may include a display panel 6061. The display panel 6061 may be configured in a form of a liquid crystal display, an organic light-emitting diode, or the like. The user input unit 607 includes at least one of a touch panel 6071 or another input device 6072. The touch panel 6071 may also be referred to as a touch screen. The touch panel 6071 may include two parts, that is, a touch detection apparatus and a touch controller. The another input device 6072 may include, but is not limited to, a physical keyboard, a function button (such as a volume control button or a power button), a track ball, a mouse, and a joystick. Details are not described herein.

In embodiments of this application, the radio frequency unit 601 receives downlink data from a network side device, and then may transmit the data to the processor 610 for processing. In addition, the radio frequency unit 601 may send uplink data to the network side device. Generally, the radio frequency unit 601 includes, but is not limited to, an antenna, an amplifier, a transceiver, a coupler, a low noise amplifier, a duplexer, and the like.

The memory 609 may be configured to store a software program or instructions and various data. The memory 609 may mainly include a first storage area for storing a program or instructions and a second storage area for storing data. The first storage area may store an operating system, an application program, or instructions required for at least one function (such as a sound playback function and a picture playback function), and the like. In addition, the memory 609 may include a volatile memory or nonvolatile memory. The non-volatile memory may be a read-only memory (ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (RAM), a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDRSDRAM), an enhanced synchronous dynamic random access memory (Enhanced SDRAM, ESDRAM), a synch link dynamic random access memory (Synch link DRAM, SLDRAM), or a direct rambus random access memory (Direct Rambus RAM, DRRAM). The memory 609 in embodiments of this application includes, but is not limited to, these and any other suitable types of memories.

The processor 610 may include one or more processing units. Optionally, an application processor and a modem processor are integrated into the processor 610. The application processor mainly processes operations related to an operating system, a user interface, an application, and the like. The modem processor mainly processes a wireless communication signal, for example, a baseband processor. It may be understood that the foregoing modem processor may alternatively not be integrated into the processor 610.

The radio frequency unit 601 is configured to send target information to a network side device by a terminal.

The target information includes at least one of the following:
a target measurement resource index;
a target measurement value, where the target measurement value includes at least one of a sub-band measurement value and a wideband measurement value; and
antenna characteristic information of the terminal.

Alternatively, the processor 610 is configured to: before the terminal sends the target information to the network side device, determine, by the terminal, the target information through first measurement based on first measurement resource configuration information.

Alternatively, the first measurement resource configuration information includes at least one of the following:
information about one or a plurality of first measurement resources, where the first measurement resource is a wideband measurement resource, transmitting beams for the plurality of first measurement resources are different, or transmitting beams for the plurality of first measurement resources having an association relationship are the same;
information about one or a plurality of second measurement resources, where the second measurement resources include a plurality of sub-band measurement resources having an association relationship, transmitting beams for sub-band measurement resources in each of the second measurement resources are the same, and transmitting beams for sub-band measurement resources in different second measurement resources are different, or transmitting beams for the sub-band measurement resources in each of the second measurement resources are different, and transmitting beams for the sub-band measurement resources in different second measurement resources are the same; and
information about one or a plurality of third measurement resource sets, where measurement resources in the third measurement resource sets are sub-band measurement resources, transmitting beams for measurement resources in each of the third measurement resource sets are the same, and transmitting beams for measurement resources in different third measurement resource sets are different, or transmitting beams for measurement resources in each of the third measurement resource sets are different, and transmitting beams for measurement resources in different third measurement resource sets are the same.

Alternatively, the first measurement includes at least one of the following:
determining, by the terminal, at least one of a wideband measurement value and N1 sub-band measurement values of the first measurement resource based on the information about the first measurement resource;
determining, by the terminal based on the information about the second measurement resource, at least one of a wideband measurement value and sub-band measurement values corresponding to N2 sub-band measurement resources of the second measurement resource; and
determining, by the terminal based on the information about the third measurement resource set, at least one of: a measurement value of a wideband measurement resource corresponding to the third measurement resource set, and sub-band measurement values corresponding to N3 sub-band measurement resources.

Alternatively, the terminal determines an operation behavior for the first measurement based on at least one of the following manners:
being configured or indicated by a network;
being specified in a protocol; and
being determined by the terminal.

Alternatively, the processor 610 is configured to:
determine, by the terminal, the target information according to a first rule after performing the first measurement; and
the first rule includes at least one of the following:
the terminal determines the target measurement value as the wideband measurement value, selects one or more target measurement resources based on a wideband measurement result, and determines the target measurement resource index as a first measurement resource index, or a second measurement resource index, or a third measurement resource set index based on the target measurement resource;
the terminal determines the target measurement value as the sub-band measurement value, selects one or more target measurement resources based on the sub-band measurement result, and determines the target measurement resource index according to a second rule; and
the terminal determines that the target measurement value includes the wideband measurement value and the sub-band measurement value, and selects one or more target measurement resources based on the wideband measurement result or the sub-band measurement result, and in addition to the wideband measurement value of the target measurement resource, the target measurement value in the target information further includes N4 sub-band measurement values corresponding to the target measurement resource; and the target information includes at least one target resource index, and the target resource index is at least one of the first measurement resource index, the second measurement resource index, the third measurement resource set index, and a third measurement resource index.

Alternatively, the first rule is configured or indicated by a network, or specified according to a default rule of a protocol, or determined by the terminal.

Alternatively, when the first rule is that the terminal determines the target measurement value as the wideband measurement value, selects one or more target measurement resources based on the wideband measurement result, and determines the target measurement resource index as the first measurement resource index, the second measurement resource index, or the third measurement resource set index based on the target measurement resource, the first rule further includes:
when the target measurement resource meets a first condition, the terminal determines that the target measurement value further includes a measurement value corresponding to a fourth measurement resource, and that the target measurement resource index further includes a resource index corresponding to the fourth measurement resource; and
the first condition includes at least one of the following:
the target measurement resource is associated with a fifth measurement resource set;
a first high-layer parameter is included in configuration information of the target measurement resource;
the first high-layer parameter is included in the configuration information of the target measurement resource, and the first high-layer parameter is set to “enabled”; and
a bit mapping corresponding to the target measurement resource is a preset value, and a sequence length of the bit mapping is the number of measurement resources in a measurement resource set to which the target measurement resource belongs.

Alternatively, the fourth measurement resource has a first spatial relationship with the target measurement resource, and the first spatial relationship meets at least one of the following:
adjacent measurement resource indexes;
having a QCL relationship; and
being configured by a network.

Alternatively, the processor 610 is specifically configured to:
determine the target information by the terminal according to a third rule when the number of target measurement resource indexes or the number of target measurement values that is determined through the first measurement is greater than 1, where
the third rule includes at least one of the following:
except that a target measurement resource index corresponding to a first target measurement resource serves as a resource index corresponding to the first target measurement resource, target measurement resource indexes of remaining target measurement resources are determined in a differential manner;
except that the target measurement value corresponding to the first target measurement resource serves as a measurement value corresponding to the first target measurement resource, target measurement values of remaining target measurement resources are determined in a differential manner; and
when a plurality of target measurement resource indexes are the same in the target information, only one target measurement resource index in the plurality of target measurement resource indexes and a target measurement value corresponding to the target measurement resource are reported.

Alternatively, the processor 610 is configured to determine, by the terminal, the first target measurement resource through at least one of the following manners:
a target measurement resource with the maximum target measurement value;
a minimum or maximum index in all the target measurement resources; and
being configured or indicated by a network.

An embodiment of this application further provides a readable storage medium. The readable storage medium stores a program or instructions. The program or the instructions, when executed by a processor, implement the processes of the foregoing method embodiments and can achieve the same technical effect. To avoid repetition, details are not described herein.

The processor is a processor of the terminal in the foregoing embodiments. The readable storage medium includes a computer-readable storage medium, such as a computer read-only memory ROM, a random access memory RAM, a magnetic disk, or an optical disk. In some examples, the readable storage medium may be a non-volatile readable storage medium.

An embodiment of this application further provides a chip. The chip includes a processor and a communication interface. The communication interface is coupled to the processor. The processor is configured to run a program or instructions to implement the processes of the foregoing method embodiments and can achieve the same technical effect. To avoid repetition, details are not described herein again.

It should be understood that the chip mentioned in this embodiment of this application may further be referred to as a system level chip, a system chip, a chip system, a system on chip, or the like.

An embodiment of this application further provides a computer program/program product. The computer program/program product is stored in a storage medium. The computer program/program product is executed by at least one processor to implement the processes of the foregoing method embodiments and can achieve the same technical effect. To avoid repetition, details are not described herein again.

An embodiment of this application further provides a wireless communication system including a terminal. The terminal may be configured to perform the steps of the terminal-side method as described above.

It should be noted that a term “comprise”, “include” or any other variant herein are intended to encompass non-exclusive inclusion, so that a process, a method, an article, or an apparatus including a series of elements not only includes those elements, but also includes another element not listed explicitly, or includes intrinsic elements for the process, the method, the article, or the apparatus. Without any further limitation, an element defined by the phrase “include one . . . ” does not exclude existence of an additional same element in the process, the method, the article, or the apparatus that includes the element. In addition, it should be noted that the scope of the method and the apparatus in the implementations of this application is not limited to function execution in the order shown or discussed and may further include function execution in a substantially simultaneous manner or in the opposite order based on the functions. For example, the described method may be performed in different order from the described order, and various steps may also be added, omitted, or combined. In addition, features described with reference to some examples may be combined in another example.

According to the descriptions of the foregoing implementations, a person skilled in the art may clearly understand that the method in the foregoing embodiments may be implemented by a computer software product with a necessary universal hardware platform, or may certainly be implemented by hardware. The computer software product is stored in a storage medium (such as a ROM, a RAM, a magnetic disk, or an optical disc) and includes several instructions to enable a terminal or a network side device to perform the methods described in embodiments of this application.

Although embodiments of this application are described above with reference to the accompanying drawings, this application is not limited to the foregoing specific implementations. The foregoing specific implementations are illustrative only but not restrictive. With the enlightenment of this application, a person of ordinary skill in the art may make many forms of implementations without departing from the concept of this application and the protection scope of the claims. These implementations fall within the protection of this application.

What is claimed is:

1. A measurement information reporting method, comprising:
sending, by a terminal, target information to a network side device,
wherein the target information comprises at least one of the following:
a target measurement resource index;
a target measurement value, wherein the target measurement value comprises at least one of a sub-band measurement value and a wideband measurement value; and
antenna characteristic information of the terminal.

2. The method according to claim 1, wherein before the sending, by a terminal, target information to a network side device, the method further comprises:
determining, by the terminal, the target information through first measurement based on first measurement resource configuration information.

3. The method according to claim 2, wherein the first measurement resource configuration information comprises at least one of the following:
information about one or a plurality of first measurement resources, wherein the first measurement resource is a wideband measurement resource, transmitting beams for the plurality of first measurement resources are different, or transmitting beams for the plurality of first measurement resources having an association relationship are the same;
information about one or a plurality of second measurement resources, wherein each of the second measurement resources comprises a plurality of sub-band measurement resources having an association relationship, transmitting beams for sub-band measurement resources in each of the second measurement resources are the same, and transmitting beams for sub-band measurement resources in different second measurement resources are different, or transmitting beams for the sub-band measurement resources in each of the second measurement resources are different, and transmitting beams for the sub-band measurement resources in different second measurement resources are the same; and
information about one or a plurality of third measurement resource sets, wherein measurement resources in the third measurement resource sets are sub-band measurement resources, transmitting beams for measurement resources in each of the third measurement resource sets are the same, and transmitting beams for measurement resources in different third measurement resource sets are different, or transmitting beams for measurement resources in each of the third measurement resource sets are different, and transmitting beams for measurement resources in different third measurement resource sets are the same.

4. The method according to claim 3, wherein the first measurement comprises at least one of the following:
determining, by the terminal, at least one of a wideband measurement value and N1 sub-band measurement values of the first measurement resource based on the information about the first measurement resource;
determining, by the terminal based on the information about the second measurement resource, at least one of a wideband measurement value and sub-band measurement values corresponding to N2 sub-band measurement resources of the second measurement resource; and
determining, by the terminal based on the information about the third measurement resource set, at least one of: a measurement value of a wideband measurement resource corresponding to the third measurement resource set, and sub-band measurement values corresponding to N3 sub-band measurement resources.

5. The method according to claim 4, wherein the terminal determines an operation behavior for the first measurement based on at least one of the following manners:
being configured or indicated by a network;
being specified in a protocol; and
being determined by the terminal.

6. The method according to claim 2, wherein the determining the target information through first measurement comprises:
determining, by the terminal, the target information according to a first rule after performing the first measurement, wherein
the first rule comprises at least one of the following:
the terminal determines the target measurement value as the wideband measurement value, selects one or more target measurement resources based on a wideband measurement result, and determines the target measurement resource index as a first measurement resource index, or a second measurement resource index, or a third measurement resource set index based on the target measurement resource;
the terminal determines the target measurement value as the sub-band measurement value, selects one or more target measurement resources based on the sub-band measurement result, and determines the target measurement resource index according to a second rule; and
the terminal determines that the target measurement value comprises the wideband measurement value and the sub-band measurement value, and selects one or more target measurement resources based on the wideband measurement result or the sub-band measurement result, and in addition to the wideband measurement value of the target measurement resource, the target measurement value in the target information further comprises N4 sub-band measurement values corresponding to the target measurement resource; and the target information comprises at least one target resource index, and the target resource index is at least one of the first measurement resource index, the second measurement resource index, the third measurement resource set index, and a third measurement resource index.

7. The method according to claim 6, wherein the first rule is configured or indicated by a network, or specified according to a default rule of a protocol, or determined by the terminal.

8. The method according to claim 6, wherein when the first rule is that the terminal determines the target measurement value as the wideband measurement value, selects one or more target measurement resources based on the wideband measurement result, and determines the target measurement resource index as the first measurement resource index, the second measurement resource index, or the third measurement resource set index based on the target measurement resource, the first rule further comprises:
when the target measurement resource meets a first condition, the terminal determines that the target measurement value further comprises a measurement value corresponding to a fourth measurement resource, and that the target measurement resource index further comprises a resource index corresponding to the fourth measurement resource; and
the first condition comprises at least one of the following:
the target measurement resource is associated with a fifth measurement resource set;
a first high-layer parameter is comprised in configuration information of the target measurement resource;
the first high-layer parameter is comprised in the configuration information of the target measurement resource, and the first high-layer parameter is set to “enabled”; and
a bit mapping corresponding to the target measurement resource is a preset value, and a sequence length of the bit mapping is the number of measurement resources in a measurement resource set to which the target measurement resource belongs.

9. The method according to claim 8, wherein the fourth measurement resource has a first spatial relationship with the target measurement resource, and the first spatial relationship meets at least one of the following:
adjacent measurement resource indexes;
having a quasi co-location QCL relationship; and
being configured by a network.

10. The method according to claim 2, wherein the determining the target information through first measurement comprises:
determine the target information by the terminal according to a third rule when the number of target measurement resource indexes or the number of target measurement values that is determined through the first measurement is greater than 1, wherein
the third rule comprises at least one of the following:
except that a target measurement resource index corresponding to a first target measurement resource serves as a resource index corresponding to the first target measurement resource, target measurement resource indexes of remaining target measurement resources are determined in a differential manner;
except that the target measurement value corresponding to the first target measurement resource serves as a measurement value corresponding to the first target measurement resource, target measurement values of remaining target measurement resources are determined in a differential manner; and
when a plurality of target measurement resource indexes are the same in the target information, only one target measurement resource index in the plurality of target measurement resource indexes and a target measurement value corresponding to the target measurement resource are reported.

11. The method according to claim 10, wherein the method further comprises:
determining, by the terminal, the first target measurement resource through at least one of the following manners:
a target measurement resource with the maximum target measurement value;
a minimum or maximum index in all the target measurement resources; and
being configured or indicated by a network.

12. A terminal, comprising:
a processor implemented in hardware and a memory storing a program or instructions executable on the processor, and when the program or the instructions are executed by the processor, the processor is directed to:
send target information to a network side device,
wherein the target information comprises at least one of the following:
a target measurement resource index;
a target measurement value, wherein the target measurement value comprises at least one of a sub-band measurement value and a wideband measurement value; and
antenna characteristic information of the terminal.

13. The terminal according to claim 12, wherein the processor is further directed to:
determine the target information through first measurement by the terminal based on first measurement resource configuration information before the terminal sends the target information to the network side device.

14. The terminal according to claim 13, wherein the first measurement resource configuration information comprises at least one of the following:
information about one or a plurality of first measurement resources, wherein the first measurement resource is a wideband measurement resource, transmitting beams for the plurality of first measurement resources are different, or transmitting beams for the plurality of first measurement resources having an association relationship are the same;
information about one or a plurality of second measurement resources, wherein each of the second measurement resources comprises a plurality of sub-band measurement resources having an association relationship, transmitting beams for sub-band measurement resources in each of the second measurement resources are the same, and transmitting beams for sub-band measurement resources in different second measurement resources are different, or transmitting beams for the sub-band measurement resources in each of the second measurement resources are different, and transmitting beams for the sub-band measurement resources in different second measurement resources are the same; and
information about one or a plurality of third measurement resource sets, wherein measurement resources in the third measurement resource sets are sub-band measurement resources, transmitting beams for measurement resources in each of the third measurement resource sets are the same, and transmitting beams for measurement resources in different third measurement resource sets are different, or transmitting beams for measurement resources in each of the third measurement resource sets are different, and transmitting beams for measurement resources in different third measurement resource sets are the same.

15. The terminal according to claim 14, wherein the first measurement comprises at least one of the following:
determining, by the terminal, at least one of a wideband measurement value and N1 sub-band measurement values of the first measurement resource based on the information about the first measurement resource;
determining, by the terminal based on the information about the second measurement resource, at least one of a wideband measurement value and sub-band measurement values corresponding to N2 sub-band measurement resources of the second measurement resource; and
determining, by the terminal based on the information about the third measurement resource set, at least one of: a measurement value of a wideband measurement resource corresponding to the third measurement resource set, and sub-band measurement values corresponding to N3 sub-band measurement resources.

16. The terminal according to claim 15, wherein the terminal determines an operation behavior for the first measurement based on at least one of the following manners:
being configured or indicated by a network;
being specified in a protocol; and
being determined by the terminal.

17. The terminal according to claim 13, wherein the processor is further directed to:
determine the target information according to a first rule after the first measurement, wherein
the first rule comprises at least one of the following:
the terminal determines the target measurement value as the wideband measurement value, selects one or more target measurement resources based on a wideband measurement result, and determines the target measurement resource index as a first measurement resource index, or a second measurement resource index, or a third measurement resource set index based on the target measurement resource;
the terminal determines the target measurement value as the sub-band measurement value, selects one or more target measurement resources based on the sub-band measurement result, and determines the target measurement resource index according to a second rule; and
the terminal determines that the target measurement value comprises the wideband measurement value and the sub-band measurement value, and selects one or more target measurement resources based on the wideband measurement result or the sub-band measurement result, and in addition to the wideband measurement value of the target measurement resource, the target measurement value in the target information further comprises N4 sub-band measurement values corresponding to the target measurement resource; and the target information comprises at least one target resource index, and the target resource index is at least one of the first measurement resource index, the second measurement resource index, the third measurement resource set index, and a third measurement resource index.

18. The terminal according to claim 17, wherein the first rule is configured or indicated by a network, or specified according to a default rule of a protocol, or determined by the terminal.

19. The terminal according to claim 17, wherein when the first rule is that the terminal determines the target measurement value as the wideband measurement value, selects one or more target measurement resources based on the wideband measurement result, and determines the target measurement resource index as the first measurement resource index, the second measurement resource index, or the third measurement resource set index based on the target measurement resource, the first rule further comprises:
when the target measurement resource meets a first condition, the terminal determines that the target measurement value further comprises a measurement value corresponding to a fourth measurement resource, and that the target measurement resource index further comprises a resource index corresponding to the fourth measurement resource; and
the first condition comprises at least one of the following:
the target measurement resource is associated with a fifth measurement resource set;
a first high-layer parameter is comprised in configuration information of the target measurement resource;
the first high-layer parameter is comprised in the configuration information of the target measurement resource, and the first high-layer parameter is set to “enabled”; and
a bit mapping corresponding to the target measurement resource is a preset value, and a sequence length of the bit mapping is the number of measurement resources in a measurement resource set to which the target measurement resource belongs.

20. The terminal according to claim 19, wherein the fourth measurement resource has a first spatial relationship with the target measurement resource, and the first spatial relationship meets at least one of the following:
adjacent measurement resource indexes;
having a quasi co-location QCL relationship; and
being configured by a network.
